(19) United States
(12) Patent Application Publication
(10) Pub. No.: US 2014/0034382 A1
(43) Pub. Date: Feb. 6, 2014

(54) ELECTRICAL CABLE FOR THE ENERGY SUPPLY OF VEHICLES

(71) Applicants: Saso Mateski, Stuttgart (DE); Ingeborg Heinrich, Stuttgart (DE)

(72) Inventors: Saso Mateski, Stuttgart (DE); Ingeborg Heinrich, Stuttgart (DE)

(73) Assignee: LAPP ENGINEERING & CO., Cham (CH)

(21) Appl. No.: 14/009,174

(22) PCT Filed: Mar. 30, 2012
(86) PCT No.: PCT/EP2012/055797

§ 371 Date: Oct. 23, 2013

(30) Foreign Application Priority Data
Apr. 1, 2011 (EP) 11160831.1

(51) Int. Cl. H01B 7/06

(52) U.S. Cl. CPC H01B 7/06
USPC 174/74 R

(57) ABSTRACT

Electrical cable (10) particularly for supplying energy to a vehicle (50), with a sheath (16), in which at least two insulated electrical conductors (12) are provided that are connected to at least one connector assembly (18) on at least one first end of the cable (10). According to the invention the sheath (16) and/or the conductors (12) and/or at least one shaping element (20) that is preferably integrated in the cable (10) are designed in such a way that the cable (10) is held with a restoring force in a resting position, in which the cable (10) exhibits the form of a spiral and is aligned along a flat or curved resting plane.

The invention relates to an electrical cable that serves for supplying energy to vehicles, a device for storing such a cable as well as a vehicle with such a cable.

In order to provide electrical energy to vehicles that are equipped with electrical drives, an electrically conducting connection needs to be established between the energy source and the vehicle. For this purpose, any electrical cable can be used that for example is drawn in a suitable length from a cable reel. Effort is therefore required each time for unwinding and rewinding the cable. However, in the event that the cable is not rewound and is left lying on the ground, damage of the cable may occur. Thereby the cable can act as a trip wire. Further, in the event that a damage of the sheath occurs the cable can cause an electrical hazard.

Furthermore, weathering of the cable can occur that is freely suspended. There is further a risk of damage and theft of the cable.

From case to case, different distances need to be bridged, so that the connection should be configured flexibly over a specific distance. Furthermore, it should be possible to bring the cable into a compact resting position after it has been used.

Nowadays, vehicles with electrical drives are sold more frequently having batteries that are recharged via electrical cables. Corresponding cables for charging the batteries are usually provided stationery at public or private charging stations. In order to be able to recharge the vehicle at a charging station or a power outlet, if no charging station with an appropriate cable is available, appropriate cables are carried inside the vehicle.

Cables for vehicles shall bridge distances of up to a few metres during the process of charging the batteries. After termination of the charging, the cable shall be brought back into a very compact resting position, particularly if it is carried in vehicle that has limited space.

From patent publication DE 42 12 207 A1, a cable device for vehicles is known, that comprises a housing and a helically coiled cable, which can be stored in the housing. The cable can be extended out of the housing and can be connected to an external power supply, in order to provide electrical current to the vehicle. The cable is an elastically extendable cable having a restoring force that, at least in the range of low elongation, is equivalent to the weight of the cable or higher. A disadvantage of the described cable device is its relatively large volume in the resting position and the large housing required therefore, in which the cable device is stored on the vehicle.

A further disadvantage of such helically coiled cables is their high restoring force. Due to this restoring force, on the one hand, considerable efforts are required from the user to bring the cable from the resting position into a working position. On the other hand, in the working position the connector assembly is loaded with the restoring force of the cable. Due to the high restoring force, the connector assembly, when connected to a counterpart, needs to be especially secured against self-acting disconnection. Otherwise, depending on the angle, the connector assembly is loaded with high shearing forces, so that corresponding constructive countermeasures are required.

A helically wound electric cable can be brought into its compact resting position only with the restoring force. In order to generate the restoring force of a helically wound cable, it must be reheated or tempered in an oven. Afterwards the cable is clamped on one end and turned in a back turning process and running against the spiral direction. Only with this process that requires manual efforts and causes considerable costs, the cable obtains the restoring force required for retracting itself into a compact resting position.

The value of the restoring force is dependent on several parameters, e.g. from the outer diameter of the helically wound electrical cable. Smaller coil diameters generate larger restoring forces as larger coil diameters. In the construction of vehicles the available space for storing cables is strongly limited. Helically wound cables with a small coiled diameter require long storage devices, which extend far into the vehicle space. When using large coil diameters the storage device does not extend as far into the vehicle space but requires a large area for the storage.

Further, cables with a large cable diameter have a larger restoring force than cables with a smaller cable diameter. Electrical cables used in electrical vehicles are often designed for fast charging of the batteries in the vehicles and therefore conduct correspondingly high currents. Due to the height of the conducted currents a correspondingly large cable cross section is required so that a large cable diameter and, accordingly, high restoring forces result.

The restoring force is also influenced by the plastic applied in the cable sheath, by the stranding of the individual strings and cable leads, and by the ambient temperature and the aging of the cable.

The restoring force of a helically wound electrical cable increases approximately proportional to the elongation of the cable. This means that the restoring force can become very high with a high elongation of the cable. Furthermore, the risk exists, that with a large elongation, particularly if this elongation is maintained over a long period of time, the restoring force may no longer retract the cable into the original resting position. Hence, with a helically wound cable maximally approx. 50% of the complete cable length can therefore be used in the working position. This means that 50% more material is required for the production of the cable, which cannot be used during operation. This causes high production costs. In addition more material and therefore a higher volume and weight need to be transported, causing higher energy requirements during operation of the vehicle.

It is therefore an object of the present invention to provide an improved electrical cable particularly for electrical vehicles. Further, a storage device for this cable as well as a vehicle equipped with this cable shall be provided.

Particularly, an electrical cable shall be provided that advantageously allows establishing a connection between a current source and a load or a storage device.

The electrical cable, with which different distances shall be bridged, shall allow advantageous handling and shall be extractable from a storage device and replaceable therein again with minimal effort.

By means of a restoring force the electrical cable shall be retractable so far into a resting position that the electrical cable requires minimal space volume in the resting position and that the storage device serving for storing the electrical cable can have a correspondingly small storage volume.

Hence, inventive storage devices shall have little space requirement. Further, it shall be possible to integrate the storage devices advantageously into the autobody of a vehicle.

Further, it shall be possible, to protect the electrical cable with little effort against weathering and vandalism.

Further, by saving cable material, resources and costs shall be reduced during manufacturing and application in vehicles.

Furthermore, by avoiding individual process steps, such as the rewinding process, production costs shall be reduced.

The above objects of the present invention are achieved with an electrical cable that exhibits the features of claim 1. Preferred embodiments of the invention are defined in further claims

The electrical cable, which can advantageously be used for supplying energy to a vehicle, comprises a sheath, in which at least two insulated electrical conductors are provided that are connected to at least one connector assembly.

According to the invention the sheath and/or the conductors and/or at least one shaping element, which is integrated into the cable, are designed in such a way that the cable is held with a restoring force self-acting in a resting position. In this resting position the cable exhibits the form of a spiral that is aligned along a flat or at least partially curved resting plane.

By means of the inherent restoring force the electrical cable is retracted after use and released into its resting position and is held in the resting position. Hence, the restoring force facilitates the transfer of the cable from a working position, in which the cable is connected for example to a current source by means of a connector assembly, into the resting position.

Due to the alignment of the electrical cables in the resting position along a plane or a flat plane, a minimal space requirement and respectively a small storage volume result. In contrast to a helically wound cable, which in the resting position comprises the form of a hollow cylinder, whose cylinder volume remains unused, the inventive cable allows maximal exploitation of the storage volume and, respectively, a high packing density of the cable. Hence, a storage device serving for receiving the electrical cable can advantageously be integrated into the autobody of a vehicle, which comprises suitable storage volumes at different positions that have a large base area and a small but sufficient height.

Due to the different diameters of the coiled windings, a non-linear restoring force results, that allows an even and easy transfer of the cable from a resting position into a working position and back. Due to the optimised restoring force, with the spiral formed windings of the cable practically the complete cable length can be used in the working position. Hence, costs for material are avoided compared to the helically wound cable, with which typically only 50% of the complete cable length can be used in the working position. Furthermore, weight is reduced, wherefore handling is facilitated.

Hence, the inventive cable provides advantages particularly for less athletic users. After opening the storage device the free end of the electrical cable that is provided with a connector assembly can be grasped by hand and can be connected to the >>energy dispenser<<. After terminating the energy transfer the connector assembly can be released by hand and can be guided back to the storage device, whereby the electrical cable returns self-acting into the initial form and, respectively, into the resting position.

Therefrom the further significant advantage results that the user does not get in contact with device parts that could be contaminated.

In a preferred embodiment, the housing wall comprises at least one spatial elevation, which engages into the adjacent spiral form of the cable. The plane or sidewall of the storage device, respectively, at which the cable lies adjacent in the resting position, is for example at least partially conically formed, so that the cable is seated in the resting position. Hence, during the seating of the cable only small forces act on the cable, so that no deformation occurs even after a longer period of time. Further, a spiral formed recess serving for receiving the cable can be embossed into the housing wall.

Preferably, the inventive cable is fixedly held at the end lying outside of the spiral and is connected to a current source, a load or a storage unit. By fixing the cable at a defined point the cable can be transferred into the resting position in a controlled manner.

In a further preferred embodiment the electrical cable is provided with at least one shaping element, which is not serving for guiding electrical current, but for form-shaping the cable. The shaping element, e.g. a spiral spring made from metal (e.g. Nitinol) or plastic, provides a desired restoring force to the cable. Hence, the electrical cable can be optimised in view of energy transfer and insulation, while the shaping element is optimised in view of permanent form-shaping and the desired restoring force. However, the individual materials of the cable can be combined with one another as required, in order to reach desired properties of the inventive cable.

In preferred embodiments it is foreseen, that the shaping element can be removed from the cable and can be replaced. In this way the cable can be brought back into the original state with little maintenance effort. In this embodiment, the shaping element is aligned at least approximately in parallel to the cable and is arranged adjacent to the sheath. For example, the form-shaping element is connected to the cable by means of clamps. Alternatively the shaping element is integrated into the cable.

Preferably, the sheath or the shaping element is made from shape memory-polymers that exhibit a shape memory-effect, and thus “remember” the former external form in spite of a strong deformation that has occurred meanwhile. The first shape memory-polymers consisted of two components. The first component was a resilient polymer, a kind of a “spring element”, the second component was a cured resin, which could arrest the “spring element” in any desired form. If the shape memory-polymer was heated, then the resin became soft and could no longer counteract the force of the polymer or the spring element respectively. Subsequently, the shape memory-polymer assumed its original form. In the present application merely one resilient element, preferably a resilient polymer is used, which serves as spring element.

The cable consists for example at least partially of a thermoplastic caoutchouc or a thermoplastic elastomer, preferably PUR and/or PVC-nitrile rubber. The electrical conductor consists preferably of copper or aluminium or of an alloy that comprises copper and/or aluminium, or that consists of conducting plastic. Thermoplastic caoutchouc or thermoplastic elastomer serves as insulation material for the sheath of the cable and that can be brought into a form by tempering, into which form the cable can be brought back again. PUR comprises in addition good mechanical properties and is abrasion-proof in particular. When using copper or aluminium or corresponding alloys, it must be taken care when stranding the lacing, but also when stranding the conductors that the cable can flexibly be moved in space. Spiral formed cables exhibit during normal use additional torsion forces. The use of softer metal alloys or conducting plastic can augment the flexibility and can avoid breaks in the cable.

In a further preferred embodiment the cable is preferably provided with magnetic or ferromagnetic elements, preferably hard-magnetic elements distributed across the complete length of the cable, continuously or in segments. Particularly advantageous is the use of a sheath that forms a flexible magnet. Hence, the electrical cable is magnetic, wherefore in addition to the mechanical restoring force a magnetic restoring force results and the cable is magnetically fixed in the resting position.

If individual magnetic elements are provided, then these magnetic elements are preferably arranged on the side of the cable that is facing the metal or magnetic housing wall of the storage device. Furthermore, the connector assembly can be provided with at least one magnetic or ferromagnetic element. Due to the effect of the magnetic elements or the magnetic material, which for example is integrated into the sheath, the cable is drawn self-acting against the metal or magnetic housing wall. Therefore, self-acting unwinding of the cable is avoided and the cable, preferably also the connector assembly, is held in an orderly and stable state. In the event that vibrations occur during the operation of the vehicle, generation of noise by the electrical cable is avoided.

Preferably, the inventive electrical cable is seated in a storage room of a device having dimensions that are adapted to the form of the spiral formed cable in the resting position. Thereby, the cable preferably lies adjacent to the largest housing wall of the storage room.

Opposite to this housing wall, a pivotally mounted or slidable cover is provided, which allows opening of the storage room. By the adaptation of the storage room to the dimension of the spiral coiled cable, the cable can be stored in the smallest possible space. Preferably, a storage room is used that comprises little depth and a base area that is by a multiple larger. The spiral coiled cable can be extracted from the storage device most easily, when the cover covers the complete cross-section of the storage room and releases the cable for use accordingly. In order to prevent the cable from theft the cover is preferably provided with a lock.

In a further preferred embodiment the storage device comprises a winch traction with a rope that is exiting in the range of the centre of the spiral out of the housing wall of the storage device and that is preferably connected to the connector assembly or two the cable close to the connector assembly. The winch traction comprises an electrical drive or a resilient element, which retracts the cable that is connected to the rope always into the resting position and thereby supports the restoring force of the cable. In addition, with the winch traction preferably a controllable restoring force can be generated.

In a preferred embodiment at least the connector assembly provided at the free end of the cable is preferably seated in a cavity of the housing wall of the storage device. By this measure the connector assembly is held protected. Furthermore, a flat design of the cover of the storage device can be achieved.

The inventive cable can be arranged advantageous in vehicles without the need of providing significant changes to the autobody. The storage device can be integrated advantageously into different parts of the autobody, which provide storage space for the spiral coiled cable. The selected part of the autobody has preferably an at least approximately flat surface with a size of preferably at least 0.09 m2 and a hollow behind. E.g., the storage device can be integrated into the deck lid, into the cowl, into a door, into the vehicle roof or into a car wing.

Hence, in vehicles that are equipped accordingly, a cable for the transfer of electrical current is always available and can easily be extracted and can be drawn over a given distance of preferably 2 m-3 m to a charging station or, respectively, to an energy dispenser.

Below the invention is described with reference to the drawings. Thereby show:

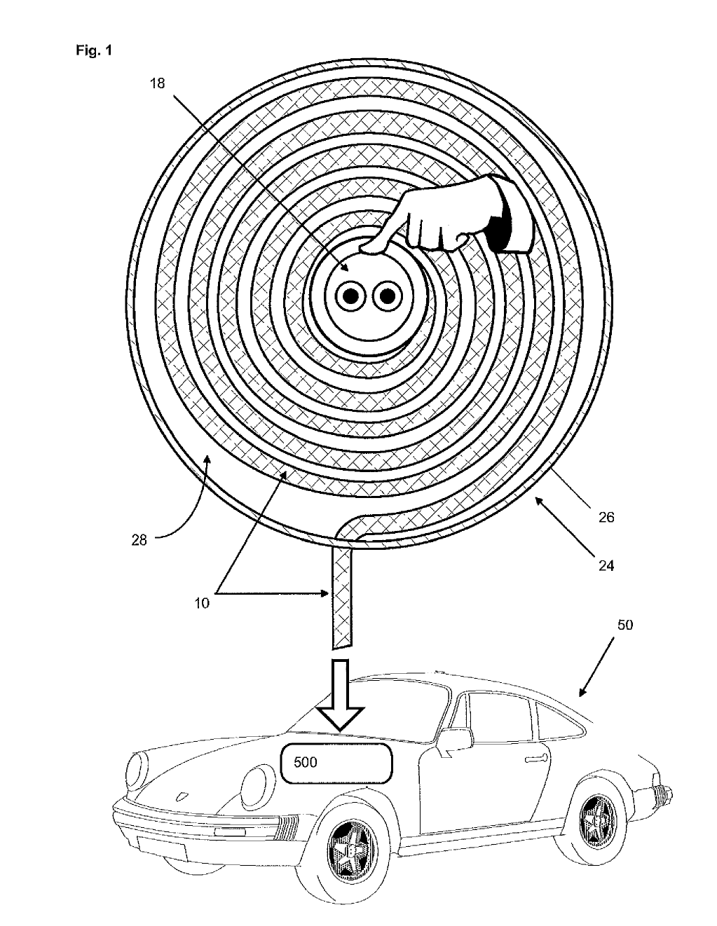

FIG. 1 an inventive electrical cable 10 with a sheath 16 and two insulated electrical conductors 12 in a resting position, in which the cable 10, which comprises the form of a spiral, is provided at the free end, which is located in the centre of the spiral, with a connector assembly 18;

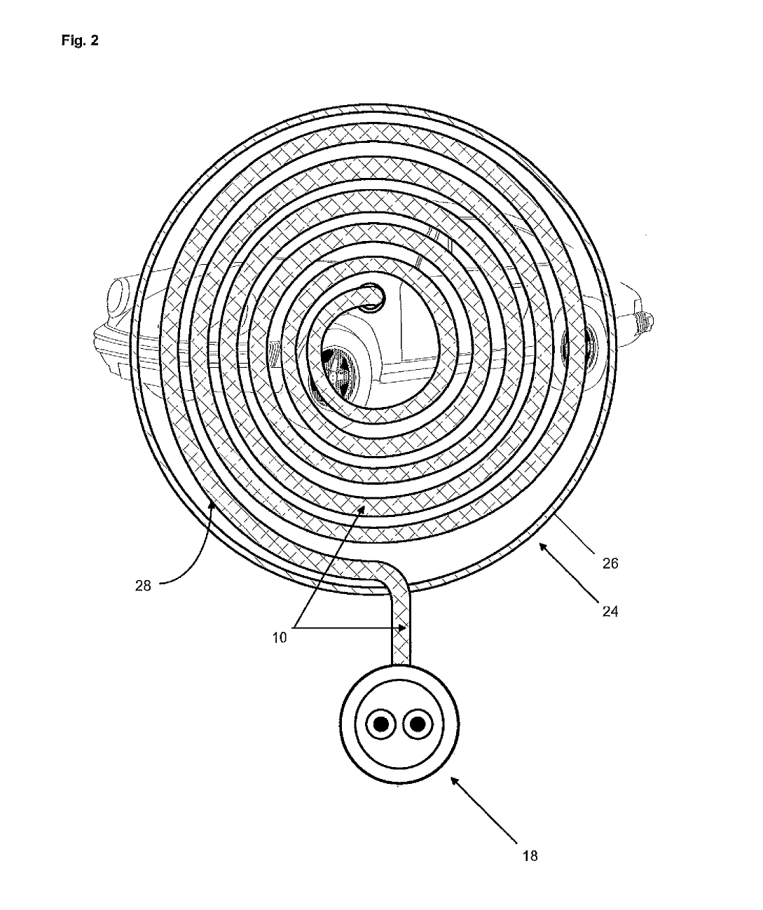

FIG. 2 the inventive cable 10 of FIG. 1 with the free end that is provided with the connector assembly 18 located on the outside of the spiral;

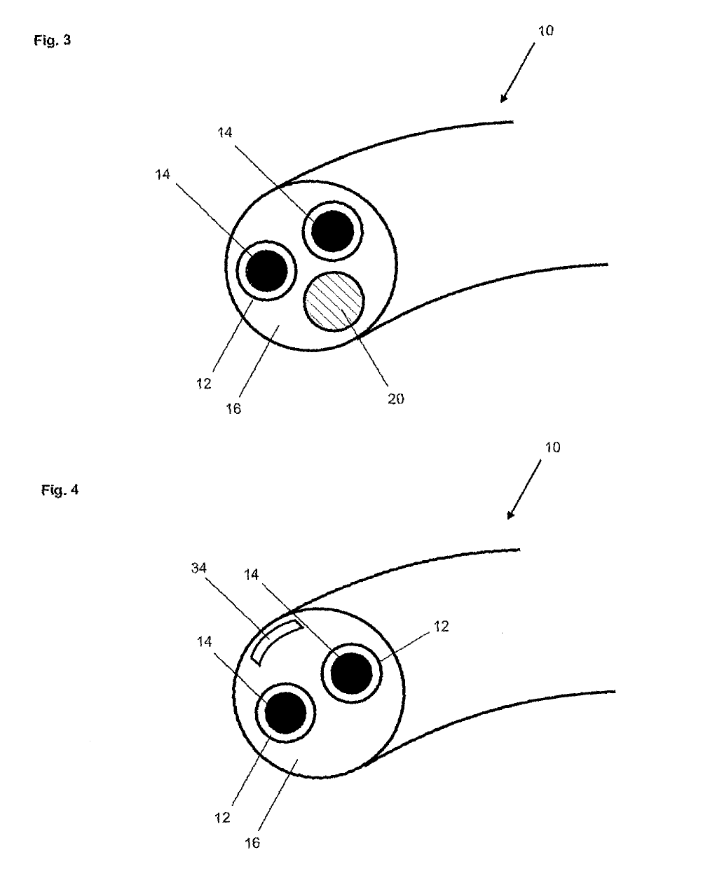

FIG. 3 a sectional view of an inventive cable 10, into which a shaping element 20 is integrated;

FIG. 4 a sectional view of an inventive cable 10, into which a magnetic or ferromagnetic element 34 is integrated;

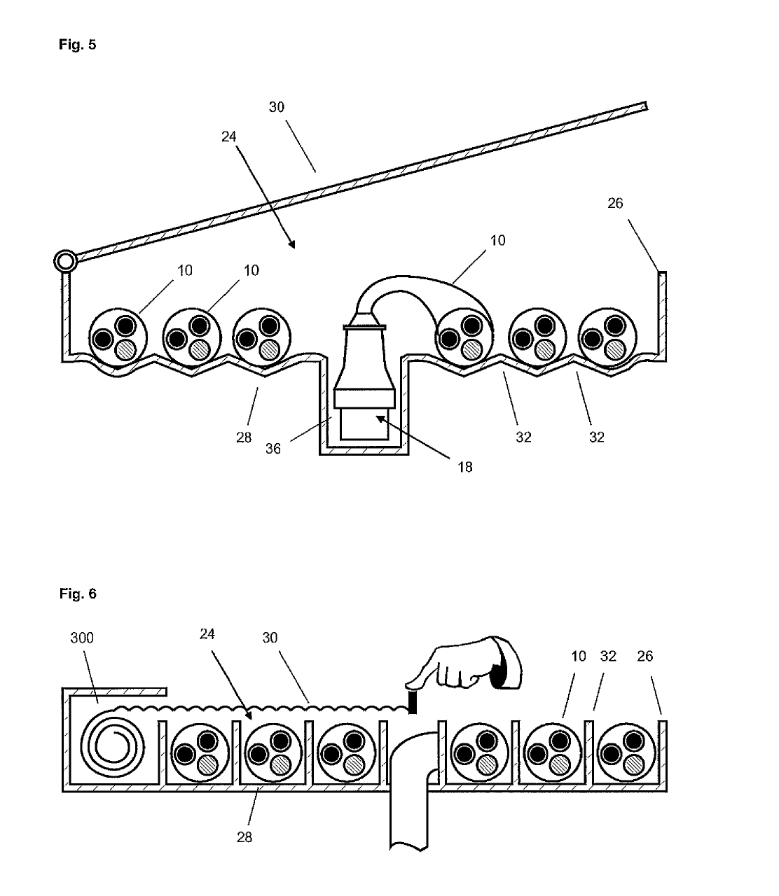

FIG. 5 a sectional view of an inventive storage device 24 that serves for supporting a cable 10 and that can be closed with a pivotally mounted cover 30;

FIG. 6 a sectional view of a further inventive storage device 24 that can be closed with a slidable cover 30;

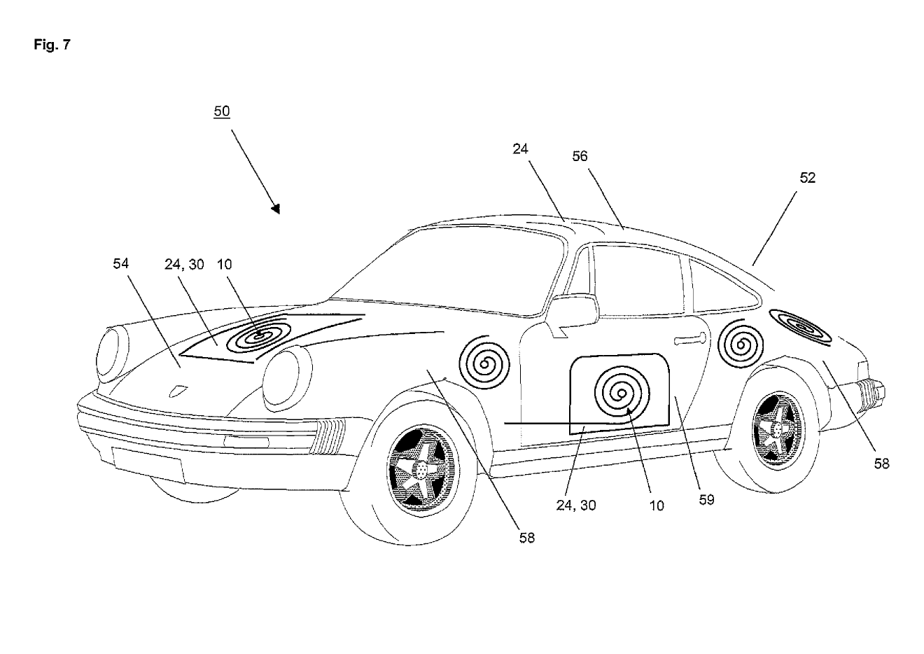

FIG. 7 a vehicle 50 with an inventive storage device 24 that is integrated into the door 59 and that can be integrated at different positions in the vehicle 50; and

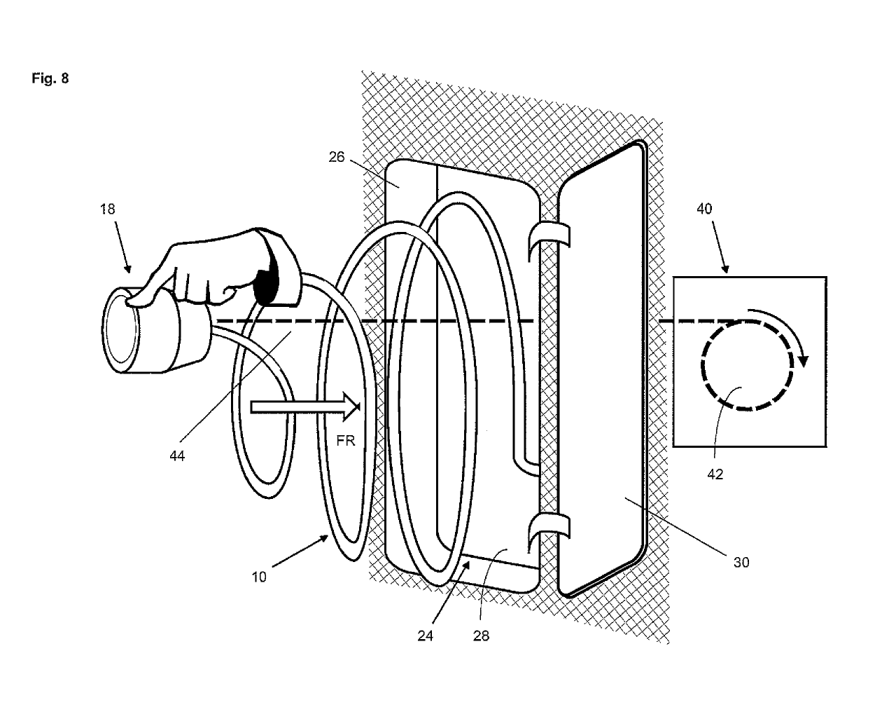

FIG. 8 a storage device 24 that is integrated for example into the autobody of a vehicle, which storage device 24 is combined in a preferred embodiment with a winch traction 40.

FIG. 1 shows an inventive cable 10, which can advantageously be used for supplying energy to vehicles 50. The cable 10 comprises a sheath 16 and at least two insulated electrical conductors 12. In addition, the cable 10 can be used for the transfer of other media or energy forms. E.g., an optical wave guide can be integrated into the cable 10.

At least at the free end, the cable 10 is provided with a connector assembly 18, with which the cable 10 can be connected to connections of an electrical device, such as a power supply unit.

Depending on the requirements defined for the cable 10, connector assemblies 18 can be mounted at both ends of the cable 10. In this way, a cable 10 results, which can be used independently from a vehicle, in which it is carried. Further, the cable 10 can be extended as required.

The cable 10 can firmly be connected on one end with an electrical device, e.g. an electrical storage unit 500 provided in a vehicle 50.

Inventive cables are manufactured in the form of a spiral, so that the cables are positioned in the resting position adjacent to a flat or curved plane and return after use in the kind of a spiral spring back into this form. The restoring force, that is required for returning the cable 10 after use into the original form or, respectively, the spiral form, can advantageously be provided by the conventional parts of the cable 10, such as the electrical conductors 12 and the sheath 16 (see FIG. 3); by additional form-shaping elements or magnet elements 20, 34 (see FIGS. 3 and 4) that are integrated into the cable 10 or connected therewith; or by external drawing devices 40. In particularly, advantageous embodiments the required restoring force are reached with a combination of suitable device parts.

Preferably, the sheath 16 or the shaping elements are made of shape memory-polymers. The cable 10 is brought into a desired spiral form e.g. by tempering. For this purpose, the cable 10 is seated onto a corresponding form element or gauge, such as a thorn, during the manufacturing processes. The cable 10 is then heated in an oven during a period of approximately 30 to 50 min with a temperature of 120° to 150°. By this process a restoring force (FR) is embossed into the cable 10, with which the cable 10 can always retract into the form and can always maintain the form, which has been defined during the tempering process.

Materials for the sheath 10 or the conductors can be for example thermoplastic plastics such as PVC or FUR. FUR is preferably used as an outer layer of the cable, since, compared to PVC, it is highly abrasive-proof. Further, elastomers, such as nitrile rubber (NBR), can be used. The mentioned materials serve on the one hand for the electrical insulation and on the other hand for form-shaping of the spiral coiled cable 10.

The form of the cable 10 can be a spiral form aligned in a plane or can be aligned in the form of a conus. Preferably, the restoring force FR provided in the cable 10 during the form-shaping process by tempering remains also in the resting position higher than zero. By this measure, also in the resting position a restoring force FR remains, which holds the cable 10 in position.

FIG. 1 further shows a storage device 24, which serves for receiving the cable 10 and which comprises a housing wall 28, at which the spiral coiled cable 10 remains adjacent in the resting position. The housing wall 28 and can be provided with a support plane that is flat or conically formed towards the inside or outside.

Adjacent to the housing wall 28 a housing frame 26 is provided, which serves for guiding and limiting the outermost winding when inserting the cable 10.

FIG. 1 shows that the connector assembly 18 provided at the free end of the cable 10 and located in the centre of the spiral can be grasped by hand, can be drawn to the connector of an >>energy dispenser<< and can there be connected with a compatible connector assembly.

FIG. 2 shows an inventive cable 10 that, compared to FIG. 1, is wound in the inverse direction. Hence, an inventive cable 10 can be wound towards the left or right. Depending on the stranding of the conductors 12 and the lacing of the conducting materials, a preferred sense of winding of the spiral results.

Normally the cable 10 will be fixedly connected with one end to an energy source, an electrical storage unit or a load. The firm connection can be located in the centre or at the outermost winding. At the opposite end the spiral coiled cable 10 is equipped with the connector assembly 18. As already mentioned, the cable 10 can be provided at both ends with a connector assembly 18.

FIG. 3 shows a sectional view of the inventive cable 10, which comprises two electrical conductors 12 that each comprises an electrically conducting material 14. Electrically conducting materials 14 that can be used are for example metals such as copper or aluminium. Besides a good electrical conductivity and a high flexibility is demanded of the conducting material 14. In order to meet the high requirements regarding flexibility, also alloys such as CuSn₆ or conducting plastic can be used. The conducting material 14 consists typically of individual fine metal wires, which are stranded in order to obtain a lacing. However, also an individual metal wire can be used.

In addition to the electrical conductors 12 a shaping element 20 is integrated in the cable 10 shown, which generates or enforces the restoring force FR of the cable 10. The shaping element 20 consists for example of a shape memory-polymer or of a plastic that is enforced with glass fibres or of a metal alloy with shape memory property, e.g. Nitinol or an arrangement of Nitinol-wire.

The shaping element 20 can be firmly integrated into the cable 10. With aging, the shaping element 20 may suffer from material fatigue or material breaks. Hence, in preferred embodiments the shaping element 20 is integrated into the cable 10 or connected therewith in such a way that it can be replaced with minimal effort.

Handling of the cable 10 can advantageously be supported by magnetic or ferromagnetic elements that are attached to the cable 10 or integrated therein. The magnetic elements can be provided in larger units or can be integrated in particle size into the elements of the cable, preferably into the sheath 16. For this purpose, the magnetic materials are pulverised, mixed with suitable plastic and are processed by calendering, extrusion, pressing or injection moulding to finished magnets.

FIG. 4 shows a sectional view of a further inventive cable 10. The cable 10 also comprises two conductors 12. In addition, at one side of the cable 10, a magnetic or ferromagnetic element 34 is provided, which serves for retracting and self-acting rewinding as well as for holding the cable in the resting position. Also the connector assembly 18 is preferably provided with magnetic- or ferromagnetic elements 34, so that it can easily be positioned and be held in the resting position.

Magnetic elements 34 can be for example hard magnets such as Neodymium-magnets (Nd₂Fe₁₄B). The magnetic force further prevents movements or vibrations of the cable 10 in the storage device 24. Even at the occurrence of high accelerations and when driving over uneven streets, the cable 10 remains securely held, thus also avoiding the generation of noise.

FIG. 5 shows a sectional view of an inventive storage device 24, in which an inventive cable 10 is stored. The spiral coiled windings of the cable 10 are seated on the housing wall 28 of the storage device 24. The housing wall comprises spiral formed recesses 32, in which the windings of the cable 10 are seated. The recesses 32 in the housing wall 28 can be embossed with a desired height. The recesses 32 safely hold the stored cable 10, wherefore the cable 10 can have reduced inherent stability. A good support of the cable 10 is also reached, when the housing wall 28 comprises a conically embossed recess that engages in the spiral path of the cable 10. If the cable 10 has a sufficient inherent stability, then the embossed recesses are not required.

The housing wall 28 further comprises a cavity 36, which can receive the connector assembly 18 that is provided in the middle of the spiral. The connector assembly 18 can also be inserted into the cavity 36 in horizontal alignment. By adapting the cavity 36 to the connector assembly 18, a storage device 24 can be provided for the cable 10, which is flat but still can accommodate a relatively large cable length and a big connector assembly 18.

FIG. 5 shows that the storage device 24 is provided with a cover 30, with which the storage device 24 can be covered after extracting or replacing the cable 10. In addition, the cover 30 can be provided with a lock that can be actuated for example with the car key. Further, an electronically controlled lock can be provided for the cover 30, which can be controlled with the armatures of the vehicle.

FIG. 6 shows a sectional view of a further storage device 24 and that comprises vertical walls 32 formed with steel sheets or recesses 32, respectively. With the vertical walls 32 the individual windings of the cable 10 are separated from one another. In this figure, the cable 10 is fixedly connected in the middle of the spiral to an electrical device, a load or a current source.

The cover 30 of the storage device 24 is slidably arranged. E.g., when opening the cover 30, it is rolled up within a chamber 300 that is located at the side. This embodiment of the cover 30 constitutes an alternative to the cover 30 discussed above. Also this embodiment can be provided with a lock.

FIG. 7 shows a vehicle 50 with storage devices 24 for receiving the inventive cable 10. The storage device 24 can be integrated at different positions into the vehicle 50. It is particularly advantageous that the storage device 24 can be positioned at various places of the vehicle 50, where at least approximately flat planes are provided. Due to the advantageous design of the inventive cable 10, already a small room depth is sufficient that is practically available in the whole area of the autobody.

E.g., the storage device 24 can advantageously be integrated in the cowl 54, in a door 59, in the vehicle roof 56, in the deck lid 52, or in a car wing 58. Particularly advantageous is the arrangement of the storage device 24 in a plane located on the upper side of the vehicle, e.g. the vehicle roof 56. This allows providing the cable 10 with an electrical coupling that is located above the vehicle 50. Hence, during the transfer of energy the surrounding area of the vehicle 50 remains free from electrical cables which could create obstacles.

FIG. 8 shows a storage device 24 that comprises a winch traction 40 with a rope 44, which enters the storage device 24 approximately in the middle of the spiral and the housing wall 28 and which is connected to one end of the cable 10 or the connector assembly 18. Thereby the rope 44 can be retracted with a drive that comprises a motor or a resilient element. The rope 44 that is guided through the centre of the spiral makes it possible, to retract the cable 10 and the connector assembly 18 with an additional restoring force FR into the resting position or to hold the cable 10 in the resting position, respectively.

Also in this working position the rope 44 is guided through the centre of the spiral. This prevents the cable 10 at least partially from sagging or turning. Further, retracting the cable 10 from the working position into the resting position is facilitated.

### LIST OF REFERENCES

10 cable
12 conductors
14 electrical conductors
16 sheath
18 connector assembly
20 additional shaping element
24 storage device
26 housing frame
28 housing wall
30 cover
300 chamber
32 embossed recesses in the housing wall
34 magnetic or ferromagnetic element
36 cavity in the housing wall
38 lock
40 winch traction
42 resilient element, spring element
44 rope
50 vehicle
500 electrical storage unit
52 deck lid
54 cowl
56 vehicle roof
58 car wing
59 door
FR restoring force

1-15. (canceled)

16. An electrical cable for supplying energy to a vehicle, the cable having a sheath enclosing at least two insulated electrical conductors, the conductors being connected to at least one connector assembly on a first end of the cable, comprising:
at least one of the sheath, the conductors and at least one shaping element integrated in the cable holds the cable with a restoring force in a resting position, wherein the cable in the resting position forms a spiral and is aligned along a flat or curved resting plane.

17. The cable according to claim 16 wherein at least a part of the resting plane is formed with a conical shape.

18. The cable according to claim 16 wherein the cable is held fixedly at an outer end of the spiral and is adapted to be connected to a current source or to a load.

19. The cable according to claim 16 wherein at least one of the sheath and the shaping element is made from a shape memory-polymer material or from a metal alloy material having a shape memory property.

20. The cable according to claim 19 wherein the metal alloy material having the shape memory property is a Nitinol material.

21. The cable according to claim 16 wherein the cable is formed at least partially of a thermoplastic caoutchouc material or a thermoplastic elastomer material.

22. The cable according to claim 16 wherein the cable is formed at least partially of at least one of a PUR material and a PVC-nitrile rubber material.

23. The cable according to claim 16 wherein the electrical conductors are formed of a copper material, an aluminum material, a copper alloy material, an aluminum alloy material, or a conducting plastic material.

24. The cable according to claim 16 wherein the at least one shaping element extends over a complete length of the cable continuously or in segments and is arranged within the sheath, outside the sheath, or embedded in the sheath.

25. The cable according to claim 24 wherein the at least one shaping element is formed of a magnetic material or a ferromagnetic material.

26. The cable according to claim 25 wherein the at least one shaping element is positioned to face a housing wall of a storage device for the cable when the cable is in the resting position.

27. The cable according to claim 16 wherein the at least one connector assembly is provided with at least one magnetic or ferromagnetic element.

28. The cable according to claim 16 including a storage device for receiving the cable, the storage device including a housing wall on which the cable is seated in the resting position and which housing wall together with a cover and a sidewall extending between the housing wall and the cover form a housing with the sidewall having a minimum height.

29. The cable according claim 28 wherein the housing wall has at least one embossed recess that engages with the cable in the resting position.

30. The cable according to claim 28 wherein the housing wall is provided with at least one magnetic or ferromagnetic element, or is formed of a magnetic or ferromagnetic material holding at least one of the cable and the at least one connector assembly by magnetic force to the housing wall.

31. The cable according to claim 28 including a winch traction positioned at the storage device and including a rope exiting at a center of the cable spiral out of the housing wall, an end of the rope being connected to the connector assembly or to the cable close to the connector assembly.

32. The cable according to claim 28 wherein the at least one connector assembly is adapted to be inserted into a cavity formed in the housing wall.

33. The cable according to claim 28 wherein the cover is held rotatably or slidably on the storage device.

34. The cable according to claim 28 wherein the storage device is installed on a vehicle.

35. The cable according to claim 34 wherein the storage device is integrated into a part of a body of the vehicle.
